(19) United States
(12) Patent Application Publication
(10) Pub. No.: US 2017/0134509 A1
(43) Pub. Date: May 11, 2017

(54) INFORMATION PROCESSING APPARATUS AND INFORMATION PROCESSING METHOD

(71) Applicant: NIKON CORPORATION, Tokyo (JP)

(72) Inventors: Takeaki SUGIMURA, Yokohama-shi (JP); Kazuyuki KAZAMI, Tokyo (JP); Atsushi TANAKA, Fuchu-shi (JP); Soichiro TSUBOI, Tokyo (JP); Genshi YOSHIOKA, Tokyo (JP); Daisuke YUKI, Yokohama-shi (JP)

(73) Assignee: NIKON CORPORATION, Tokyo (JP)

(21) Appl. No.: 15/412,750

(22) Filed: Jan. 23, 2017

Related U.S. Application Data
(63) Continuation of application No. PCT/JP2015/072517, filed on Aug. 7, 2015.

(30) Foreign Application Priority Data
Aug. 8, 2014 (JP) 2014-162083

(51) Int. Cl. H04L 29/08; H04N 9/31; G06K 9/20; G06K 9/00

(52) U.S. Cl. CPC H04L 67/18; G06K 9/00288; G06K 9/00355; H04N 9/31; G06K 9/20; H04L 67/06

(57) ABSTRACT

An information processing apparatus includes: a storage unit that stores data that belongs to a user; a movement prediction unit that predicts a movement destination of the user; and a transmission unit that transmits the data that belongs to the user to an apparatus provided at the movement destination.

### CROSS-REFERENCE TO RELATED APPLICATION

This is a Continuation Application of International Application No. PCT/JP2015/072517, filed on Aug. 7, 2015, which claims priority on Japanese Patent Application No. 2014-162083, filed on Aug. 8, 2014. The contents of the aforementioned applications are incorporated herein by reference.

### BACKGROUND

Field of the Invention

The present invention relates to an information processing apparatus and an information processing method.

Background

In the related art, in a print proxy store that includes an in-store LAN to which edit and print output means and the like are connected, a customer computer that is connected to the in-store LAN may be provided. The in-store LAN is connected to a network outside the store to which a server of a data management center that manages data of a plurality of stores is connected, and data created by a customer and data created in relation to a customer are stored in a customer data storage unit of the server for each customer to which an ID is given (for example, refer to Japanese Unexamined Patent Application, First Publication No. 2002-056085).

### SUMMARY

However, in the above-described system, when an user such as a customer performs a job using data that belongs to the user such as data that has been created in the past using an information processing apparatus which is used by a large number of unspecified users such as the customer computer, it is necessary to acquire data that belongs to the user and that is stored the server provided outside, and therefore, there is a problem that, when a data amount is large, a time may be required to acquire the data.

An aspect of the present invention provides an information processing apparatus which is used by a large number of unspecified users and which is capable of immediately performing a job using data that belongs to a user and an information processing method of the information processing apparatus.

An aspect of the present invention is an information processing apparatus that includes: a storage unit that stores data that belongs to a user; a movement prediction unit that predicts a movement destination of the user; and a transmission unit that transmits the data that belongs to the user to an apparatus provided at the movement destination.

Another aspect of the present invention is an information processing method of an information processing apparatus. The method includes: storing data that belongs to a user; predicting a movement destination of the user; and transmitting the data that belongs to the user to an apparatus provided at the movement destination.

According to an aspect of the present invention, it is possible to immediately perform a job using data that belongs to a user in an information processing apparatus which is used by a large number of unspecified users.

### BRIEF DESCRIPTION OF THE DRAWINGS

FIG. 1 is a schematic block diagram showing a configuration of an information processing system according to a first embodiment of the present invention.

FIG. 2 is a schematic view showing an example of a usage status of an information processing apparatus according to the first embodiment.

FIG. 3 is a schematic block diagram showing a configuration of the information processing apparatus according to the first embodiment.

FIG. 4 is a flowchart for describing an operation example of a movement prediction unit and a data transmission unit according to the first embodiment,

FIG. 5 is a schematic block diagram showing a configuration of an information processing apparatus according to a second embodiment of the present invention.

FIG. 6 is a flowchart for describing an operation example of a movement prediction unit and a data transmission unit according to the present embodiment.

FIG. 7 is a schematic block diagram showing a configuration of an information processing apparatus according to a third embodiment of the present invention.

### DESCRIPTION OF THE EMBODIMENTS

### First Embodiment

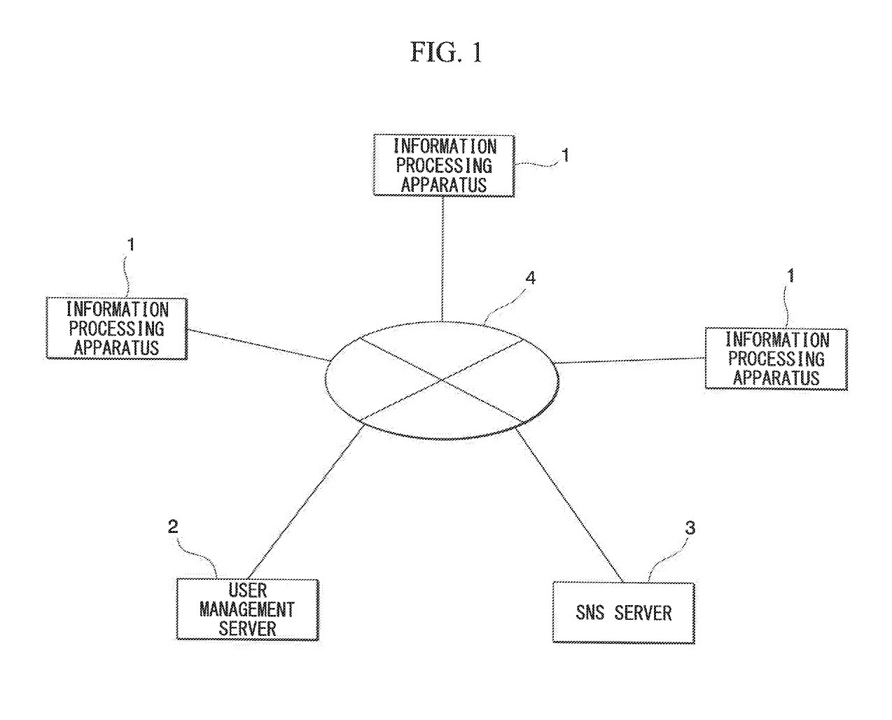

Hereinafter, a first embodiment of the present invention is described with reference to the drawings. FIG. 1 is a schematic block diagram showing a configuration of an information processing system according o the first embodiment of the present invention. The information processing system according to the present embodiment includes a plurality of information processing apparatuses 1, a user management server 2, a SNS (Social Networking Service) server 3, and a network 4. The information processing apparatus 1 is an information processing apparatus 1 used by a user and is provided at a variety of places. At least one of the information processing apparatuses 1 is provided at a store or the like and can be used by a large number of unspecified users. The user management server 2 is a server that manages user's information such as data that belongs to a user. The SNS server 3 is a server that provides a so-called social networking service and provides information that is posted by a user.

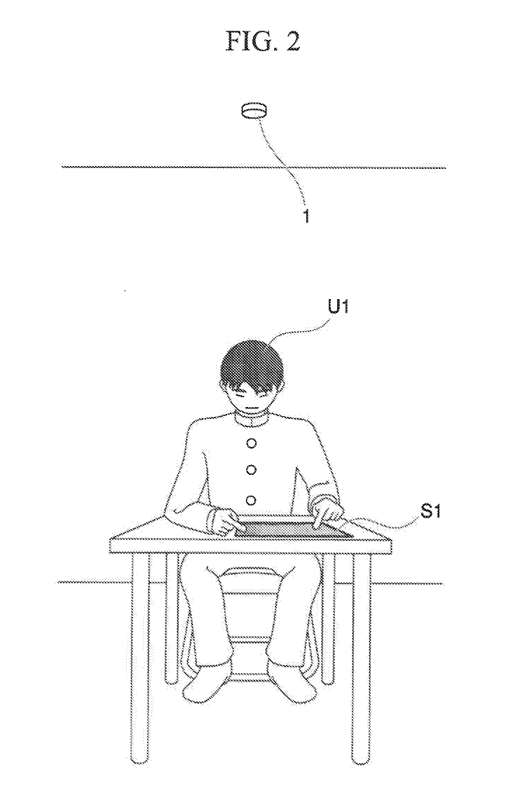

FIG. 2 is a schematic view showing an example of a usage status of the information processing apparatus 1. In FIG. 2, the information processing apparatus 1 is provided at a ceiling such that the information processing apparatus 1 can project an image downward or toward a wall surface of a room or such that the information processing apparatus 1 can capture an image of a user U1. The information processing apparatus 1 projects user data that is stored or an image corresponding to a gesture of the user U1. The information processing apparatus 1 predicts a movement destination of the user U1 and transmits data that belongs to the user U1 of data stored by the information processing apparatus 1 to an information processing apparatus 1 provided at the predicted movement destination.

Examples of the data that belongs to the user U1 include an environmental image that is projected on a wall surface or a floor surface of a room as a wallpaper, information indicating a correspondence between each gesture and a process that should be performed by the information processing apparatus 1 when the user UI performs the gesture, a usage history of each information processing apparatus 1 by the user U1, and a content which the user U1 owns. Examples of the process that should be performed by the information processing apparatus 1 include execution of a specific application program and execution of a specific function included in the application program during execution.

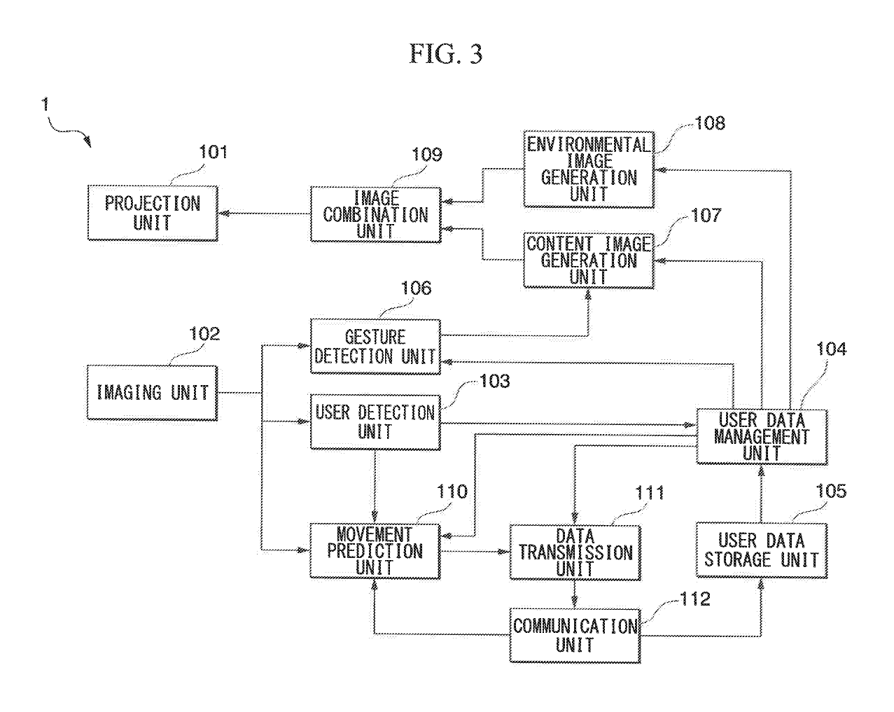

FIG. 3 is a schematic block diagram showing a configuration of the information processing apparatus 1. The information processing apparatus 1 includes a projection unit 101, an imaging unit 102, a user detection unit 103, a user data management unit 104, a user data storage unit 105, a gesture detection unit 106, a content image generation unit 107, an environmental image generation unit 108, an image combination unit 109, a movement prediction unit 110, a data transmission unit 111, and a communication unit 112.

The projection unit 101 is a projector that projects an input image onto a wall surface or a floor surface of a room in which the information processing apparatus 1 is provided. The imaging unit 102 captures an image of the inside of the room in which the information processing apparatus 1 is provided. The user detection unit 103 detects a user from the image captured by the imaging unit 102. The user detection unit 103 distinguishes the detected user, for example, according to face recognition or the like and notifies the user data management unit 104 of a user ID indicating the distinguished user.

When the user detection unit 103 notifies the user data management unit 104 of the user ID, subsequently, the user data management unit 104 reads out data that belongs to the user of the notified user ID from the user data storage unit 105. The user data storage unit 105 stores data that belongs to each user in association with a user ID of the user.

The gesture detection unit 106 detects a gesture by the user from the image captured by the imaging unit 102. The gesture is a specific posture posed by a user or a specific motion. The gesture detection unit 106 extracts, from the data that belongs to the user and that is read out by the user data management unit 104, information indicating a correspondence between the detected gesture and the process that should be performed when the gesture is detected. The gesture detection unit 106 notifies the content image generation unit 107 of performing the process that is associated by the extracted information.

The content image generation unit 107 performs the process of which the gesture detection unit 106 notifies the content image generation unit 107, generates a content image, and determines the position to which the content image is projected. The content image generation unit 107 may use the data that belongs to the user and that is read out by the user data management unit 104 when generating the content image or determining the projection position. For example, the content image generation unit 107 plays a content that is owned by the user of the data that belongs to the user and that is read out by the user data management unit 104 to thereby generate the content image and determines the projection position in accordance with information that designates the projection position when playing the content of the data that belongs to the user.

The environmental image generation unit 108 acquires an environmental image that is projected on a wall surface or a floor surface of a room as a wallpaper of the data that belongs to the user and that is read out by the user data management unit 104 and inputs the acquired environmental image to the image combination unit 109. The image combination unit 109 overlaps the content image generated by the content image generation unit 107 with the image input from the environmental image generation unit 108 at a position determined by the content image generation unit 107 to combine the images and inputs the combined result to the projection unit 101 to be projected.

When the user detection unit 103 does not detect the user, the movement prediction unit 110 acquires data that belongs to the user and that is read out by the user data management unit 104 and that belongs to the user that becomes undetected, data relating to the user acquired from the user management server 2, the SNS server 3, or the like, and data of a motion, clothes, and the like of the user detected from the image captured by the imaging unit 102 before the user becomes undetected. The movement prediction unit 110 predicts the movement destination of the user with reference to the acquired data. The movement prediction unit 110 may predict a plurality of movement destinations.

With respect to the prediction of the movement destination by the movement prediction unit 110, for example, a place which is described in a schedule of the user and which is stored by the SNS server 3, the user management server 2, the user data storage unit 105, and the like may be the predicted movement destination. Alternatively, from the usage history of the information processing apparatus 1 included in the data that belongs to the user, an arrangement place of the information processing apparatus 1 at which the use frequency is high on the day of the week, during the period of time, and in the weather state or a weather state indicated by the weather forecast may be the predicted movement destination. Alternatively, the clothes and personal belongings of the user may be determined from the image captured by the imaging unit 102, and the place that is associated in advance with the determination result may be the movement destination. For example, when wearing a school uniform or carrying a bag used for attending a school, the school is predicted as the movement destination.

The data transmission unit 111 transmits, via the communication unit 112, the data that belongs to the user and that is read out by the user data management unit 104 to the information processing apparatus 1 provided at the movement destination predicted by the movement prediction unit 110. When the user management server 2 stores the data that belongs to the user, the data transmission unit 111 may request the user data management unit 104 to transmit the data that belongs to the user to the movement destination.

The communication unit 112 communicates with another apparatus (the information processing apparatus 1, the user management server 2, the SNS server 3) connected via the network 4. The communication with another apparatus by each unit of the information processing apparatus 1 is performed via the communication unit 112. When receiving the data that belongs to the user from another information processing apparatus 1, the communication unit 112 stores the data in the user data storage unit 105.

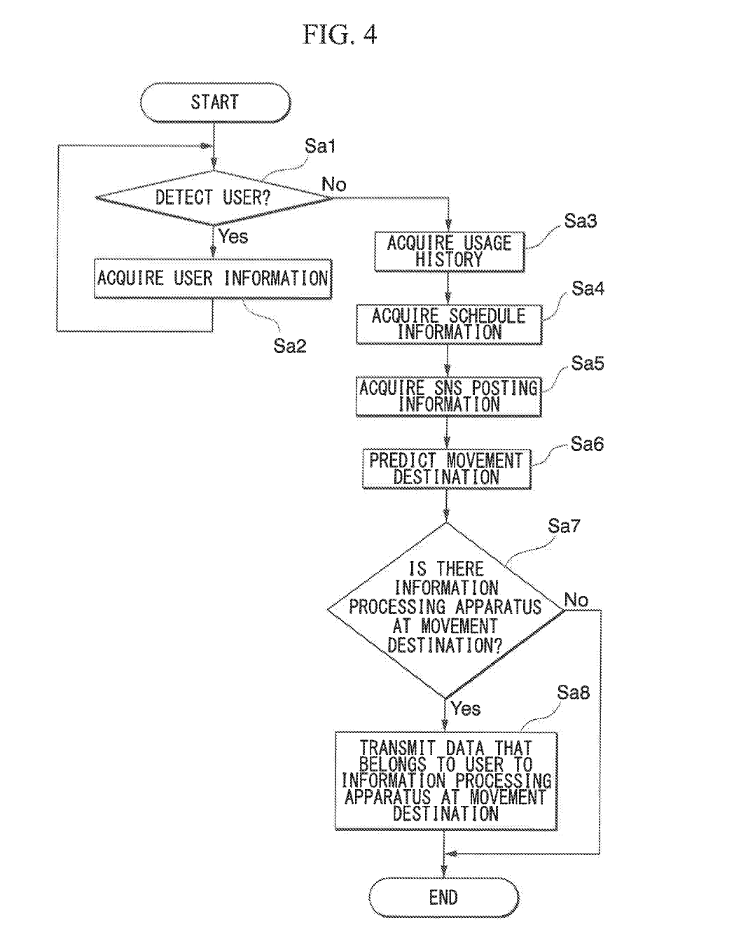

FIG. 4 is a flowchart for describing an operation example of the movement prediction unit 110 and the data transmission unit 111. First, the movement prediction unit 110 stands by until the user is not detected by the user detection unit 103 from the image captured by the imaging unit 102 (Step Sa1, Step Sa2). Next, the movement prediction unit 110 acquires the usage history of the information processing apparatus 1 of the data that belongs to the user and that is read out by the user data management unit 104 and that belongs to the user that becomes undetected (Step Sa3). Next, the movement prediction unit 110 acquires schedule information of the data that belongs to the user (Step Sa4). Next, the movement prediction unit 110 acquires information representing the schedule of the user of the information that is posted on the SNS server 3 (Step Sa5).

The movement prediction unit 110 predicts the movement destination of the user by using the information acquired in Step Sa3 to Step Sa5 (Step Sa6). Next, the data transmission unit 111 determines whether or not the information processing apparatus 1 is provided at the movement destination which is predicted in Step Sa6 (Step Sa7). When the information processing apparatus 1 is not provided (Step Sa7—No), the process is completed. On the other hand, when the information processing apparatus 1 is provided (Step Sa7—Yes), the data that belongs to the user and that is read out by the user data management unit 104 is transmitted to the information processing apparatus 1 at the movement destination (Step Sa8), and the process is completed.

The data transmission unit 111 may transmit part of the data that belongs to the user to another information processing apparatus 1. For example, the function of the information processing apparatus 1 provided at the movement destination is limited, or When the function available for the user is limited, the data that cannot be used due to the limitation may be excluded from the data that is transmitted.

In this way, the information processing apparatus 1 includes the user data storage unit 105, the movement prediction unit 110, and the data transmission unit 111, The user data storage unit 105 (storage unit) stores data that belongs to a user. The movement prediction unit 110 predicts a movement destination of the user. The data transmission unit 111 (transmission unit) transmits the data that belongs to the user to the information processing apparatus 1 provided at the movement destination.

Thereby, when the user moves to the predicted movement destination, the data that belongs to the user has been transmitted to the information processing apparatus 1 provided at the movement destination, and therefore, it is possible to immediately perform a job using the data that belongs to the user even when the information processing apparatus 1 is an information processing apparatus which is used by a large number of unspecified users.

The information processing apparatus 1 includes the user detection unit 103 that detects a user. Further, when the user is not detected by the user detection unit 103, the data transmission unit 111 transmits the data that belongs to the user to the information processing apparatus 1 provided at the movement destination.

Thereby, during the user is within a detection range by the information processing apparatus 1 and there is no possibility that the user uses another information processing apparatus 1, the data that belongs to the user is not transmitted to another information processing apparatus 1, and therefore, it is possible to prevent useless transmission of the data.

The movement prediction unit 110 predicts a plurality of movement destinations of the user, and the data transmission unit 111 transmits the data that belongs to the user to the information processing apparatus 1 provided at each of the plurality of movement destinations.

Thereby, even when the prediction accuracy of the movement destination is low, it is possible to enhance the possibility that, when the user moves, the data that belongs to the user may have been transmitted to the information processing apparatus 1 at the movement destination.

The movement prediction unit 110 predicts the movement destination by using the movement history of the user, the schedule information of the user, the posted information of the user to another service, or weather information.

Thereby, it is possible to increase the prediction accuracy of the movement destination by performing a prediction corresponding to the movement tendency in the past, the schedule that has already been determined, the schedule of which the user notifies another person, the weather, and the like.

Further, the imaging unit that captures the image of the user is included, and the movement prediction unit 110 predicts the movement destination by using clothes or personal belongings of the imaged user.

Thereby, it is possible to increase the prediction accuracy of the movement destination by performing a prediction corresponding to the clothes or personal belongings of the user at that time.

### Second Embodiment

Hereinafter, a second embodiment of the present invention is described with reference to the drawings. An information processing system according to the second embodiment also has a configuration similar to FIG. 1 but is different in that the information processing system has an information processing apparatus 1a in place of the information processing apparatus 1.

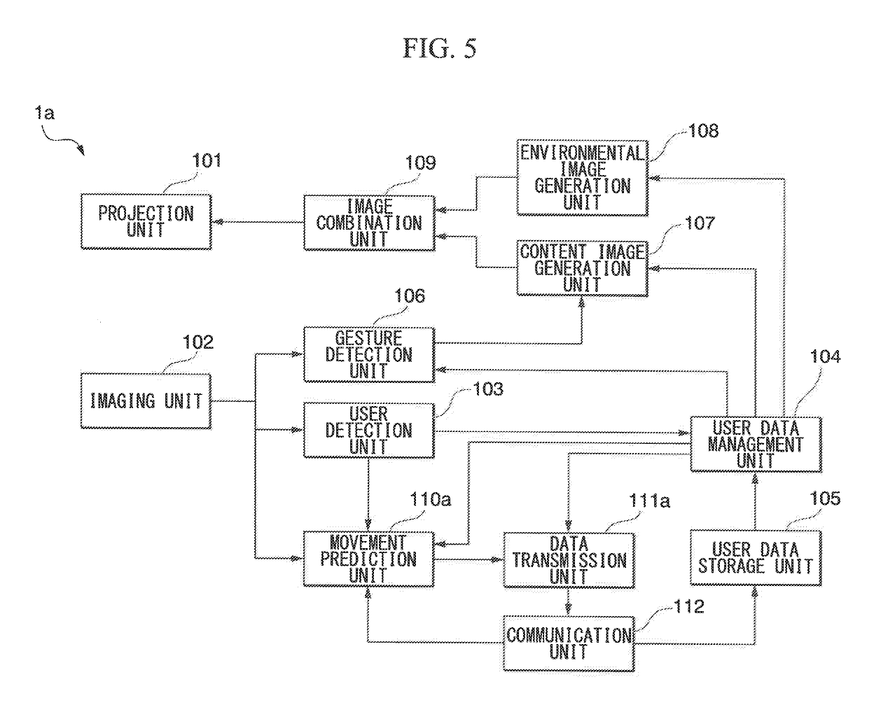

FIG. 5 is a schematic block diagram showing a configuration of the information processing apparatus 1a. In FIG. 5, the same reference numeral (101 to 109, 112) is given to a part corresponding to each unit of FIG. 3, and description of the part is omitted. The information processing apparatus 1a includes a projection unit 101, an imaging unit 102, a user detection unit 103, a user data management unit 104, a user data storage unit 105, a gesture detection unit 106, a content image generation unit 107, an environmental image generation unit 108, an image combination unit 109, a movement prediction unit 110a, a data transmission unit 111a, and a communication unit 112.

The movement prediction unit 110a predicts the movement destination similar to the movement prediction unit 110 of FIG. 3 but is different from the movement prediction unit 110 of FIG. 3 in that the prediction is performed when the user is detected and in that the arrival time to the movement destination of the user is predicted. As the arrival time, a time designated in the schedule may be used, or a time obtained by adding a time required to the movement destination to the time when the user becomes undetected may be used.

The data transmission unit 111a transmits the data that belongs to the user to the information processing apparatus 1a provided at the movement destination similarly to the data transmission unit 111 of FIG. 3 but is different in that the data transmission unit 111a determines a time (transmission start time) when transmission is started such that the data that belongs to the user is transmitted before the user arrives at the movement destination and starts transmission at the time. The data transmission unit 111a determines that a time obtained by subtracting a time corresponding to the amount of the transmitted data from the arrival time predicted by the movement prediction unit 110a is the transmission start time. The time corresponding to the amount of the transmitted data may be, for example, stored in advance in association with each data amount or may be calculated by using the ratio of a data amount to a time which is stored in advance.

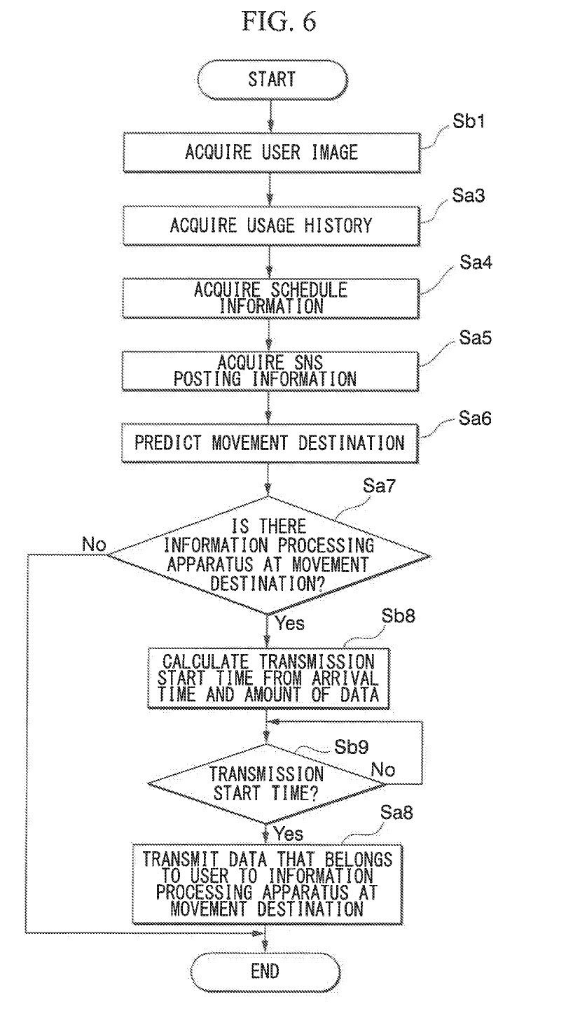

FIG. 6 is a flowchart for describing an operation example of the movement prediction unit 110a and the data transmission unit 111a. In FIG. 6, the same reference numeral (Sa3 to Sa5, Sa7, and Sa8) is given to a part corresponding to each step of FIG. 4, and description of the part is omitted. The flowchart shown in FIG. 6 is different from the flowchart of FIG. 4 in that the flowchart shown in FIG. 6 has only Step Sb1 before Step Sa3, in that the flowchart shown in FIG. 6 has Step Sb6 in place of Step Sa6, and in that the flowchart shown in FIG. 6 has Step Sb8 and Step Sb9 between Step Sa7 and Step Sa8.

In Step Sb1, when the user detection unit 103 detects the user, the movement prediction unit 110a acquires the image of the user captured by the imaging unit 102. In Step Sb6, the movement prediction unit 110a predicts the arrival time to the movement destination of the user in addition to the movement destination. In Step Sb8, the data transmission unit 111a calculates the transmission start time from the arrival time predicted in Step Sb6 and the amount of the data that belongs to the user. In Step Sb9, the data transmission unit 111a stands by until the transmission start time calculated in Step Sb8.

In this way, similarly to the information processing apparatus 1, the information processing apparatus 1a can also immediately perform a job using the data that belongs to the user even when the information processing apparatus 1a is an information processing apparatus which is used by a large number of unspecified users.

Further, the movement prediction unit 110a predicts the arrival three to the movement destination in addition to the movement destination of the user, and the data transmission unit 111a transmits the data that belongs to the user to the information processing apparatus 1 provided at the movement destination before the arrival time.

Thereby, for example, in a case Where the movement time is short, it is possible to prevent a situation that transmission of the data that belongs to the user is not completed even when the user arrives at the movement destination from occurring.

### Third Embodiment

Hereinafter, a third embodiment of the present invention is described with reference to the drawings. An information processing system according to the third embodiment also has a configuration similar to FIG. 1 but is different in that the information processing system has an information processing apparatus 1b in place of the information processing apparatus 1.

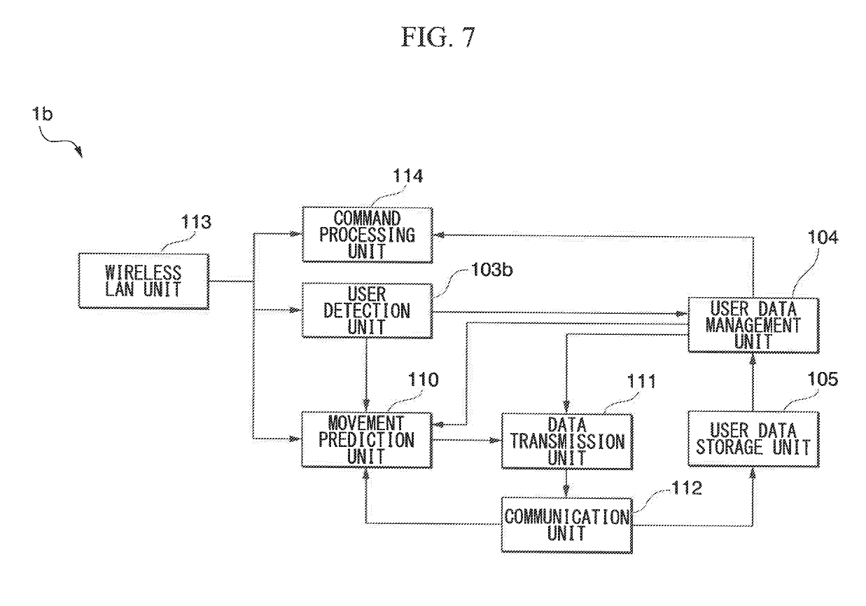

FIG. 7 is a schematic block diagram showing a configuration of the information processing apparatus 1b. In. FIG. 7, the same reference numeral (104, 105, 110, 111, and 112) is given to a part corresponding to each unit of FIG. 3, and description of the part is omitted. As shown in FIG. 7, the information processing apparatus 1b includes a user detection unit 103b, a user data management unit 104, a user data storage unit 105, a movement prediction unit 110, a data transmission unit 111, a communication unit 112, a wireless LAN unit 113, and a command processing unit 114.

The wireless LAN unit 113 communicates with a device (hereinafter, referred to as a user device) carried by a user such as a smartphone and a tablet according to a wireless LAN such as WiFi. The user detection unit 103b acquires a user ID via the wireless LAN unit 113 from a user device located in a communication zone and thereby detects a user. The user detection unit 103b may acquire a device ID such as a MAC address of the user device from the user device and convert the acquired device ID into a user ID by using a correspondence of a user ID and a device ID that is stored in advance.

The command processing unit 114 acquires an acquisition request of data (for example, video content) that belongs to the user from the user device via the wireless LAN unit 113. The command processing unit 114 reads out the data requested by the acquisition request from the user data storage unit 105 via the user data management unit 104. The command processing unit 114 transmits the data which is read out to the user device via the wireless LAN unit 113.

The movement prediction unit 110 may acquire position information according to a GPS (Global Positioning System) of the user device or the like via the wireless LAN unit 113 and use the position information for movement prediction of the user. The movement prediction of the user may be performed by using connection information of the user device to a portable base station, connection information of the user device to a WiFi access point, and motion history information including position information stored in the user device.

When a user is not detected by the user detection unit 103b, the user data management unit 104 may delete data that belongs to the user from the user data storage unit 105. The deletion can be performed using any of the information processing apparatuses 1b other than an information processing apparatus 1b (for example, one provided at the user's home) which is set in advance,

In this way, even in the present embodiment, the data that belongs to the user is moved corresponding to the movement of the user. Therefore, for example, video content recorded in the information processing apparatus 1b at the user's home can be copied in advance into the information processing apparatus 1b at the visiting destination, and the user can view the video content via a local network connection according to a wireless LAN. Thereby, the user can acquire data that belongs to the user independent of a traffic amount of the network 4. For example, when the data that belongs to the user is video content, the user can view the video content stably independent of the traffic of the network 4.

The information processing apparatus 1 according to an embodiment of the present invention includes: a memory (the user data storage unit 105) that stores data that belongs to a user; and a circuitry (the movement prediction unit 110, the data transmission unit 111, the data transmission unit 111a) configured to (1) predict a movement destination of the user and (2) transmit the data that belongs to the user to an apparatus provided at the movement destination.

A program for realizing the functions of the information processing apparatus 1 in FIG. 1 and the information processing apparatuses 1a, 1b may be recorded in a computer-readable recording medium, and the program recorded in the recording medium may be read into and executed on a computer system to thereby realize the information processing apparatus 1 and the information processing apparatuses 1a, 1b. It is assumed that the “computer system” used herein includes an OS or hardware such as peripherals.

The term “computer-readable recording medium” refers to a portable medium such as a flexible disk, a magneto-optical disk, a ROM, and a CD-ROM, or a storage device such as a hard disk embedded in the computer system. It is also assumed that the term “computer-readable recording medium” includes a medium which dynamically holds a program for a short time such as a communication line in a case where a program is transmitted through a network such as the Internet or a communication line such as a telephone line and a medium which holds a program for a given time such as a volatile memory in the computer system which becomes a server or a client in the case. The program may be a program which can realize part of the above-described functions. Further, the program may be a program which can realize the above-described functions by a combination with a program already recorded in the computer system.

Although embodiments of the invention have been described in detail referring to the drawings, a specific configuration is not limited to the embodiments, and design changes and the like can be made without departing from the scope of the invention.

What is claimed is:

1. An information processing apparatus comprising;
a storage unit that stores data that belongs to a user;
a movement prediction unit that predicts a movement destination of the user; and
a transmission unit that transmits the data that belongs to the user to an apparatus provided at the movement destination.

2. The information processing apparatus according to claim 1, comprising:
a user detection unit that detects a user, wherein
when the user is not detected by the user detection unit, the transmission unit transmits the data that belongs to the user to the apparatus provided at the movement destination,

3. The information processing apparatus according to claim 1, wherein
the movement prediction unit predicts an arrival time to the movement destination in addition to the movement destination of the user, and
the transmission unit transmits the data that belongs to the user to the apparatus provided at the movement destination before the arrival time.

4. The information processing apparatus according to claim 1, wherein
the movement prediction unit predicts a plurality of movement destinations of the user, and
the transmission unit transmits the data that belongs to the user to an apparatus provided at each of the plurality of movement destinations.

5. The information processing apparatus according to claim 1, wherein
the movement prediction unit predicts the movement destination by using a movement history of the user, schedule information of the user, posted information of the user to another service, or weather information.

6. The information processing apparatus according to claim 1, comprising:
an imaging unit that captures an image of a user, and
the movement prediction unit predicts the movement destination by using clothes or personal belongings of the imaged user.

7. The information processing apparatus according to claim 1, wherein
the transmission unit determines whether or not the apparatus is provided at the movement destination and transmits the data that belongs to the user to the apparatus when the apparatus is provided at the movement destination.

8. An information processing method of an information processing apparatus, the method comprising:
storing data that belongs to a user;
predicting a movement destination of the user; and
transmitting the data that belongs to the user to an apparatus provided at the movement destination.
